(19) United States
(12) Patent Application Publication
(10) Pub. No.: US 2020/0364736 A1
(43) Pub. Date: Nov. 19, 2020

(54) SYSTEMS AND METHODS FOR RECYCLING MATERIALS

(71) Applicant: Mazin YOUSIF, Portland, OR (US)

(72) Inventor: Mazin YOUSIF, Portland, OR (US)

(21) Appl. No.: 16/410,083

(22) Filed: May 13, 2019

(51) Int. Cl. G06Q 30/02; G06Q 10/00

(52) U.S. Cl. CPC G06Q 30/0216; G06Q 10/30

(57) ABSTRACT

A system for recycling materials at recycling facilities comprises a processor and memory storing instructions. When executed by the processor, the instructions cause the processor to register the recycling facilities and the persons that recycle the materials at the recycling facilities, and to purchase a plurality of securities including securities associated with the recycling facilities and securities of interest to the persons. The instructions cause the processor to receive, from a first recycling facility of the recycling facilities, in response to a first person of the persons recycling the materials at the first recycling facility, a value of the recycled materials and identifying information of the first recycling facility and of the first person. The instructions cause the processor to allocate a portion of the plurality of securities to an account associated with the first person based on the value of the recycled materials.

### FIELD

The present disclosure relates to systems and methods for recycling materials.

### BACKGROUND

The background description provided here is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Growing environmental concerns among people are driving growth of the recycling industry. People tend to recycle materials such as plastic, aluminum, clothing, electronics, inkjet cartridges, toys, furniture, and so on. Recycling is often rewarded with cash, coupons, vouchers, discounts, points, debit cards, and so on. These rewards, however, may not be exciting or inspiring to promote recycling. Accordingly, a reward system that can encourage recycling is needed.

### SUMMARY

A system to reward persons for recycling materials at recycling facilities comprises a processor and memory storing instructions. When executed by the processor, the instructions cause the processor to register the recycling facilities and the persons that recycle the materials at the recycling facilities. The instructions cause the processor to purchase a plurality of securities including securities associated with the recycling facilities and securities of interest to the persons. The instructions cause the processor to receive, from a first recycling facility of the recycling facilities, in response to a first person of the persons recycling the materials at the first recycling facility, a value of the recycled materials and identifying information of the first recycling facility and of the first person. The instructions cause the processor to allocate a portion of the plurality of securities to an account associated with the first person based on the value of the recycled materials and the identifying information of the first recycling facility and of the first person received from the first recycling facility.

In other features, in response to the first person recycling the materials at the first recycling facility, prior to receiving the value of the recycled materials and the identifying information of the first recycling facility and of the first person, the instructions further cause the processor to receive, from the first recycling facility, a first identifying information provided to the first person by the system when the first person registered with the system; and to send, to the first recycling facility, in response to receiving the first identifying information, a second identifying information provided to the system by the first person when the first person registered with the system.

In other features, the instructions further cause the processor to, in response to a plurality of the persons recycling the materials at the first recycling facility, receive from the first recycling facility in real-time or in one or more batches, values of the recycled materials and identifying information of the first recycling facility and of the plurality of the persons.

In other features, the instructions further cause the processor to display the allocated securities in the account associated with the first person and to update prices of the displayed securities based on real-time data feeds received from a securities exchange.

In other features, the instructions further cause the processor to allow the first person to sell the allocated securities and to communicate, directly or via a brokerage firm, a sell order of the first person to a securities exchange.

In other features, the system further comprises a network interface configured to communicate with the recycling facilities, a securities exchange, and a brokerage firm via a communications network.

In still other features, a system to reward a person registered with a reward system for recycling materials at a recycling facility that is also registered with the reward system comprises a processor and memory storing instructions. When executed by the processor, the instructions cause the processor to provide the person, in response to receiving the materials from the person at the recycling facility, an option to purchase securities or to receive an item in exchange for the materials. The instructions cause the processor to receive from the person, in response to the person selecting the option to purchase securities, a first identifying information provided to the person by the reward system when the person registered with the reward system. The instructions cause the processor to send the first identifying information to the reward system. The instructions cause the processor to receive, in response to sending the first identifying information to the reward system, a second identifying information from the reward system. The second identifying information is provided to the reward system by the person when the person registered with the reward system. The instructions cause the processor to confirm an identity of the person based on the second identifying information received from the reward system. The instructions cause the processor to send to the reward system, for allocating the securities proportional to a value of the materials to an account of the person, in response to confirming the identity of the person, the value of the materials, the first identifying information of the person, and an identifying information of the recycling facility provided by the reward system to the recycling facility when the recycling facility registered with the reward system.

In other features, in response to being unable to confirm the identity of the person based on the second identifying information, the instructions further cause the processor to again receive the first identifying information from the person, send the first identifying information to the reward system, receive the second identifying information from the reward system, and confirm the identity of the person based on the second identifying information.

In other features, in response to again being unable to confirm the identity of the person based on the second identifying information, the instructions further cause the processor to allow dispensing the item of value equivalent to the value of the materials to the person in exchange for the materials, where the item includes cash, coupon, points, or voucher.

In other features, the system further comprises a point of sale terminal and a scanner configured to scan a receipt indicating the value of the materials. The instructions further cause the processor to display on the point of sale terminal the value of the materials by scanning the receipt and the option to purchase the securities or to receive the item in exchange for the materials.

In other features, the system further comprises a scanner configured to scan an identification of the person. The instructions further cause the processor to obtain a third identifying information by scanning the identification and to confirm the identity of the person based on the second and third identifying information.

In other features, in response to being unable to confirm the identity of the person based on the second and third identifying information, the instructions further cause the processor to again receive the first identifying information from the person, send the first identifying information to the reward system, receive the second identifying information from the reward system, obtain the third identifying information, and confirm the identity of the person based on the second and third identifying information.

In other features, in response to again being unable to confirm the identity of the person based on the second and third identifying information, the instructions further cause the processor to dispense the item of value equivalent to the value of the materials to the person in exchange for the recycling material, where the item includes cash, coupon, points, or voucher.

In other features, the system further comprises a network interface configured to communicate with the reward system via a communications network.

In still other features, a machine registered with a reward system that rewards persons for recycling materials is configured to receive recycling material from a person who is also registered with the reward system. The machine comprises a receptacle to receive the recycling material from the person. The machine comprises a processor and memory storing instructions. When executed by the processor, the instructions cause the processor to display, in response to receiving the recycling material, an option to purchase securities or to receive an item in exchange for the recycling material. The instructions cause the processor to receive from the person, in response to the person selecting the option to purchase securities, a first identifying information provided to the person by the reward system when the person registered with the reward system. The instructions cause the processor to send the first identifying information to the reward system. The instructions cause the processor to receive, in response to sending the first identifying information, a second identifying information from the reward system. The second identifying information is provided to the reward system by the person when the person registered with the reward system. The instructions cause the processor to receive a third identifying information from the person. The instructions cause the processor to confirm an identity of the person based on the second and third identifying information. The instructions cause the processor to send to the reward system, for allocating the securities proportional to a value of the recycling material to an account of the person, in response to confirming the identity of the person, the value of the recycling material, the first identifying information of the person, and an identifying information assigned to the machine by the reward system when the machine was registered with the reward system.

In other features, the instructions further cause the processor to determine the value of the recycling material and to display the value along with the option to purchase the securities or to receive the item in exchange for the recycling material.

In other features, the machine further comprises a scanner configured to scan an identification of the person. The instructions further cause the processor to obtain the third identifying information by scanning the identification.

In other features, in response to being unable to confirm the identity of the person based on the second and third identifying information, the instructions further cause the processor to again receive the first identifying information from the person, send the first identifying information to the reward system, receive the second identifying information from the reward system, receive the third identifying information from the person, and confirm the identity of the person based on the second and third identifying information.

In other features, in response to again being unable to confirm the identity of the person based on the second and third identifying information, the instructions further cause the processor to dispense the item of value equivalent to the value of the recycling material to the person in exchange for the recycling material, where the item includes cash, coupon, points, or voucher.

In other features, the machine further comprises a network interface configured to communicate with the reward system via a communications network.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a system comprising an equity reward system of the present disclosure;

FIG. 2 shows an example of a recycling facility that can communicate with the equity reward system of the present disclosure;

FIG. 3 shows a simplified example of a distributed computing system that can implement the equity reward system of the present disclosure;

FIG. 4 shows a simplified example of a client device of FIG. 3;

FIG. 5 shows a simplified example of a server of FIG. 3;

FIG. 6 shows a method for registering a client with the equity reward system of the present disclosure;

FIG. 7 shows a method for registering a recycling facility with the equity reward system and for providing capabilities to a point-of-sale (POS) system at the recycling facility to perform functions according to the equity reward system;

FIG. 8 shows a method performed by the equity reward system for allocating securities to clients' accounts corresponding to cash values of material recycled by the clients;

FIG. 9 shows a method of authenticating a client's identity when the client selects an equity reward option at a recycling facility;

FIG. 10 shows a method of updating clients' accounts and facilitating liquidation of clients' holdings in the clients' accounts;

FIG. 11 shows a method for registering a recycling machine with the equity reward system and for providing capabilities to the recycling machine to perform the operations described with reference to FIGS. 2, 7, and 9; and

FIG. 12 shows a method of dispensing equity and non-equity rewards to a client that deposits recycling materials at the recycling machine of FIG. 11.

In the drawings, reference numbers may be reused to identify similar and/or identical elements.

### DETAILED DESCRIPTION

The present disclosure proposes a system and a method to reward people with an equity stake in companies that accept recycling material or in companies that promote recycling (e.g., companies that brand themselves as green companies or environment-friendly companies). The rewards may be in the form of securities such as stocks, bonds, mutual funds, index funds, and so on of these companies, which are routinely traded on various securities exchanges. Such an equity reward system, which differs from the traditional reward systems described above, will likely incentivize people to recycle more, particularly with companies that accept recycling material and that offer equity in those companies in exchange for the recycled materials. The equity reward system can incentivize people to recycle more because people owning securities tend to feel better about themselves and their future prospects—considerably more than when they receive points, cash, coupons, vouchers, and so on.

The equity reward system of the present disclosure operates as follows. A person can register and open an account with the equity reward system using a mobile application or a web portal of the equity reward system. The person can provide information regarding what materials are typically recycled, the facilities where they are typically recycled, and what types of rewards are preferred in exchange for recycling, including types of securities preferred (e.g., securities of the facilities where materials are typically recycled or of other companies). The person can provide identifying information that can be used to verify the person's identity when the person recycles materials at a recycling facility. The equity reward system issues the person an ID number upon completing registration, which can be presented at a recycling facility to verify the person's identity when the person recycles materials at the recycling facility. A person can also register family members under the person's account. The equity reward system issues each family member a separate ID number that can be presented to verify the member's identity when a family member recycles materials.

Various recycling companies and recycling facilities can also register with the equity reward system. The point-of-sale (POS) systems of such companies and facilities can be equipped (e.g., upgraded, configured, extended, augmented, or installed anew) by the equity reward system to offer both traditional rewards and securities as rewards to people in exchange for recycling materials at these companies and facilities. The POS systems can be further equipped by the equity reward system to verify a person's identity by exchanging the person's identifying information with the equity reward system when the person recycles materials and elects an equity reward instead of a traditional reward. On verifying the person's identity, the POS system can send a cash value of the recycled materials to the equity reward system in real time or in a batch mode (i.e., after collecting several transactions). The equity reward system purchases a basket of securities and allocates securities equivalent to the cash value of the materials recycled by a person into the person's account. The person can view the securities in the account and sell the securities at any time.

In use, a person who has an account in the equity reward system delivers recycling material to a location. The location can be a store (e.g., a grocery store), a collection facility, a recycling facility, a garbage/recycling center, or a company that collects and/or recycles material (collectively recycling facilities). For example, a person may return plastic bottles, aluminum cans, and/or glass bottles to a grocery store (e.g., Kroger). A person may deliver used clothing to a clothing retail company (e.g., H&M, Levies Straus). A person may deliver children's used toys, bassinets, car seats, etc. to toy retailers or children's stores. A person may return inkjet cartridges to electronics stores (e.g., Best Buy, Staples) or Inkjet cartridge collection companies (e.g., Clover Technologies, Best Buy). A person may deliver used electronics (e.g., computers, monitors, phones, tablets) to an electronics store (e.g., Best Buy, Staples). A person may deliver used furniture and appliances to furniture and appliance stores; and so on.

The recycling facility, which is also registered with equity reward system, collects the recycling material. The recycling facility can ascertain the exact cash value of the recycling material (e.g., in case of returned bottles/cans) or can assess a cash value of the recycling material. As mentioned above, in conventional approaches, the recycling facility may reward the person one or more of the following: the exact cash value of the returned material (e.g., in case of returned bottles/cans); points equivalent to the cash value of the returned material and based on rewarding policies of the facility; coupons with expected savings, when redeemed, approximately equal to the cash value of the returned material; or vouchers with expected value, when used, approximately equal to the cash value of the returned material.

Instead, the equity reward system of the present disclosure rewards the person as follows. The recycling facility offers the person a choice between receiving one of the above traditional rewards and receiving a security equivalent to a cash value of the recycled materials. If the recycling facility supports one or more of the above traditional options, the recycling facility allows the person to choose between one such supported traditional options as listed above. Alternatively, the recycling facility also allows the person to select a security option (e.g., purchase a stock of the facility or another stock of the person's choice, but not of a competitor, or a mutual fund, etc.).

The specific type and quantity of the security (e.g., shares of stock) rewarded to the person by the equity reward system may vary as follows. For example, the security can be the stock of the company that owns the business/facility that collects the recycling material. For example, if a person returns plastic/glass bottles and/or cans to a grocery store for recycling, the person could be rewarded stock of the grocery store (e.g., Kroger, Costco). If a person delivers clothing or fabric to a clothing store for recycling, the person could be rewarded stock of the clothing store (e.g., H&M, Levis Straus). If a person returns inkjet cartridges to a store that collects inkjet cartridges for recycling, the person could be rewarded stock of that store (e.g., Clover technologies). If a person delivers electronics items to a store that collects electronics items for recycling, the person could be rewarded stock of that store (e.g., Best Buy, Staples); and so on.

The security offered as a reward can also be from a basket or portfolio of stocks (e.g., stocks of companies that promote recycling, that brand themselves as green companies or environmentally friendly companies, and so on). The quantity of the security (e.g., the number of shares) depends on the current price of the security and the cash value of the recycled material.

Companies that currently offer the traditional rewards for recycling can be registered with the equity reward system. The POS systems of these companies can be upgraded or configured (or installed anew) to offer securities as rewards in addition to or instead of the traditional rewards. Further, the POS systems can be equipped with additional hardware and/or software that can support other features of the equity reward system such as authenticating or verifying a person's identity.

If a recycling company is still private, the recycling company cannot offer the security option but can offer the traditional rewards for recycling. Alternatively, if the company has devised a scheme to reward recycling, the cash (or points) that would have been given to the person recycling can be used to purchase securities from the person's favorite companies. In this scenario, the cash value of the recycled material is added to the person's account at the equity reward system.

When the person elects the security option at the recycling facility, the POS system sends the person's ID number, which is assigned by the equity reward system, to the equity reward system for verification. The equity reward system returns the name of the person to the POS system. If the person's name is the same as the name received from the equity reward system (e.g., verified using a government issued ID such as a driver's license or a passport), the identity of the person is confirmed, and the POS system can send transaction data to the equity reward system.

Many other alternative methods of authentication and identity verification are contemplated. For example, the equity reward system may issue to a person a recycling card similar to ATM cards or cards used for loyalty programs. The POS system can read or scan the recycling card to verify the identity of the person through the equity reward system. Alternatively, the POS system may be equipped to capture biometric information (e.g., a fingerprint, or a scan of an eye, ear, or face) of the person and send the captured biometric information to the equity reward system for verification. Using the biometric information for identity verification may be more robust than all other methods of identity verification described herein and may therefore replace all the other methods. In some implementations, the biometric method may be used in conjunction with other methods of authentication and identity verification. For the authentication and identity verification processes described herein, any one of the described approaches (e.g., the ID number provided by the reward system, the recycling card provided by the reward system, biometric data, etc.) may suffice. Alternatively, any combination of the described approaches may also suffice. The selection of any one or combination of the described approaches may depend on regulatory requirements of the geographic region where the systems and methods of the present disclosure are implemented.

Throughout the present disclosure, any reference to verifying identity of a person using a government issued ID includes and is not limited to verifying the identity using one or more of these items regardless of whether these items are specifically recited in each reference: a driver's license or a passport (or any other form of reliable identification including a recycling card issued by the equity reward system), or the person's biometric information, and so on. Any omission of one or more these items may be for brevity.

After verifying the identity of the person, the POS system can send transaction data to the equity reward system. For example, the transaction data can include facility's name and address and ID registered with the equity reward system, the person's ID, the cash value of the recycled material, and date and time of day of the transaction. The POS system can send the transaction data to the equity reward system in real time or in a batch mode (at predetermined time or times during the day after accumulating such data until such time or times). The equity reward system then sends an acknowledgement to the POS system of the recycling facility confirming that the transaction data has been received by the equity reward system.

Throughout the present disclosure, any reference to transaction data includes and is not limited to these items regardless of whether these items are specifically recited in each reference: facility's name and address and ID registered with the equity reward system, the person's ID, the cash value of the recycled material, and date and time of day of the transaction. Any omission of one or more these items may be for brevity. Further, throughout the present disclosure, whether mentioned or not, whenever the equity reward system receives transaction data from a recycling facility or machine, the equity reward system sends an acknowledgement to the recycling facility or machine confirming that the transaction data has been received by the equity reward system.

If, however, the person's name is not the same as the name received from the equity reward system, the POS system can send the person's ID number once more to the equity reward system for verification. This allows for correction of any typographical errors or any communication errors that may have occurred during the previous transmission/reception. The POS system again receives the person's name from the equity reward system. If the person's name is the same as the name received from the equity reward system, the identity of the person is confirmed, and the POS system can send the transaction data to the equity reward system. The equity reward system then sends an acknowledgement to the POS system confirming that the transaction data has been received by the equity reward system. If the person's name is still not the same as the name received from the equity reward system, the identity of the person is not confirmed (e.g., the person may not have an account with the equity reward system), and the POS system does not offer the equity reward option to the person. Instead, the POS system offers the person one of the traditional rewards or cash for the recycled materials.

In this manner, the equity reward system can receive the transaction data from various recycling locations. The equity reward system can store the transaction data in respective clients' accounts in a temporary database and can flag the transactions as pending or not yet completed/settled. Accordingly, when the client views the account, a dashboard can display two regions: previously settled and currently non-settled securities. Alternatively, the equity reward system can store all non-settled transactions in one temporary database and not reflect them on the clients' accounts until they are settled as follows.

At a predetermined time or times of the day (or at any time of the day including real time—as soon as a transaction is received from a recycling facility), the equity reward system can purchase securities of companies that are registered with the equity reward system and that receive recycling material. The equity reward system can also purchase a basket of securities of other companies. At midnight (or at some selected specific time or times of the day), the equity reward system can pull the transaction data from the temporary database one client at a time and can convert the cash value of the client's recycled material to a corresponding security according to the preference indicated by the client in the client's profile/account. The equity reward system then adds the purchased security positions to (reflect on) the clients' accounts. The equity reward system can vary the time when to settle the security transactions based on the value of the security of the recycling company.

The equity reward system can receive data feeds to reflect changes to the prices of the securities owned by the registered clients. The clients can view the securities in their accounts by logging into their accounts via the web portal of the equity reward system or by using a mobile application. The clients can liquidate their holdings at any time. The equity reward system forwards the sell orders to a brokerage firm that executes the trades at a securities exchange. If the equity reward system is authorized to execute trades on the securities exchanges, the equity reward system may also directly forward and execute the sell orders at a securities exchange. Upon settlement of the trades, the equity reward system makes the funds available in the clients' accounts. The clients can withdraw or transfer the funds as they choose. These and other features of the equity reward system of the present disclosure are described below in detail.

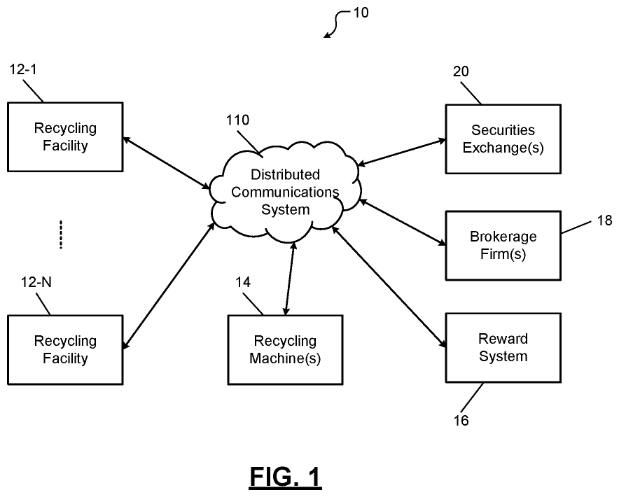

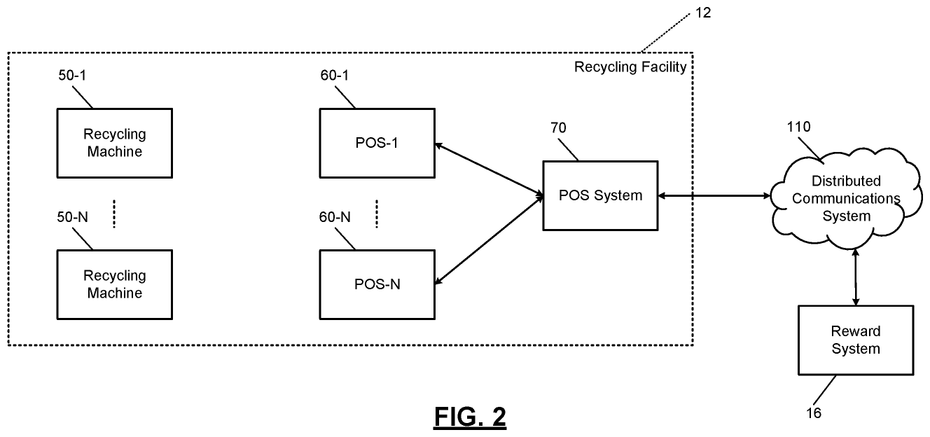

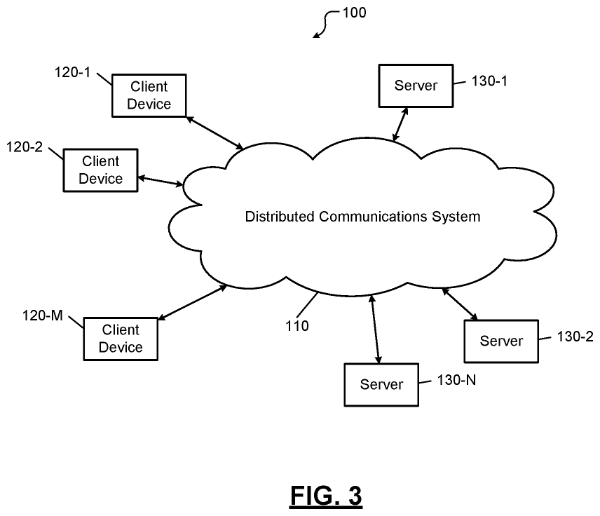

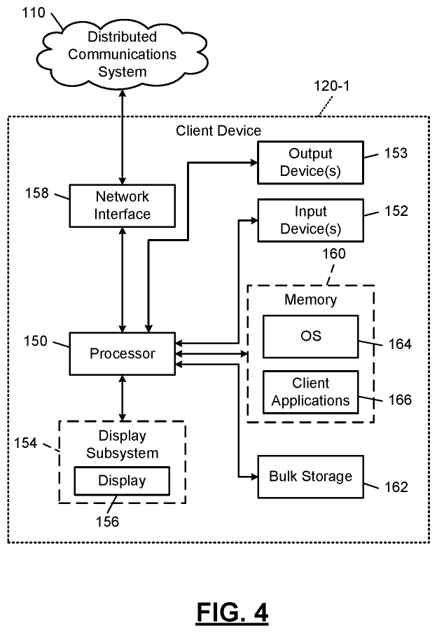

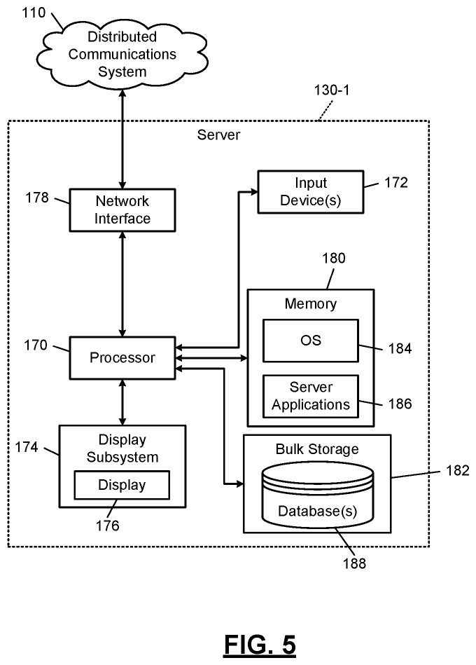

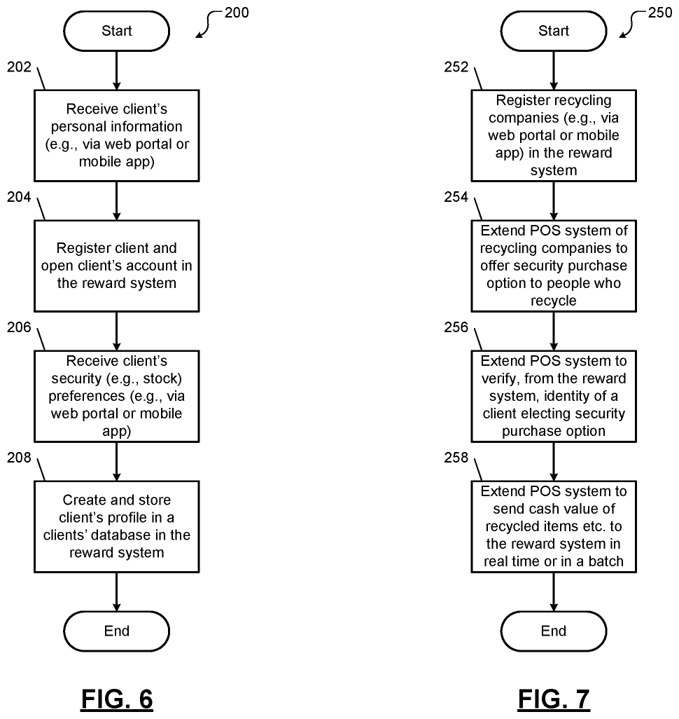

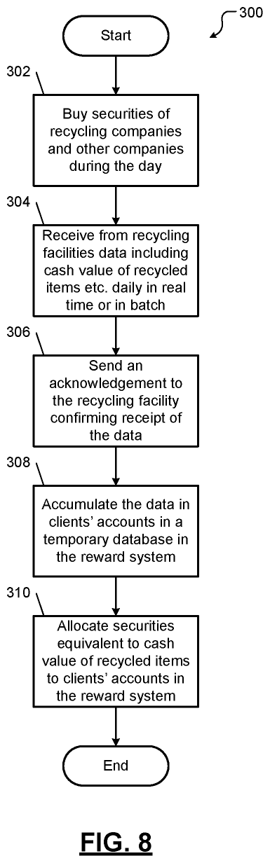

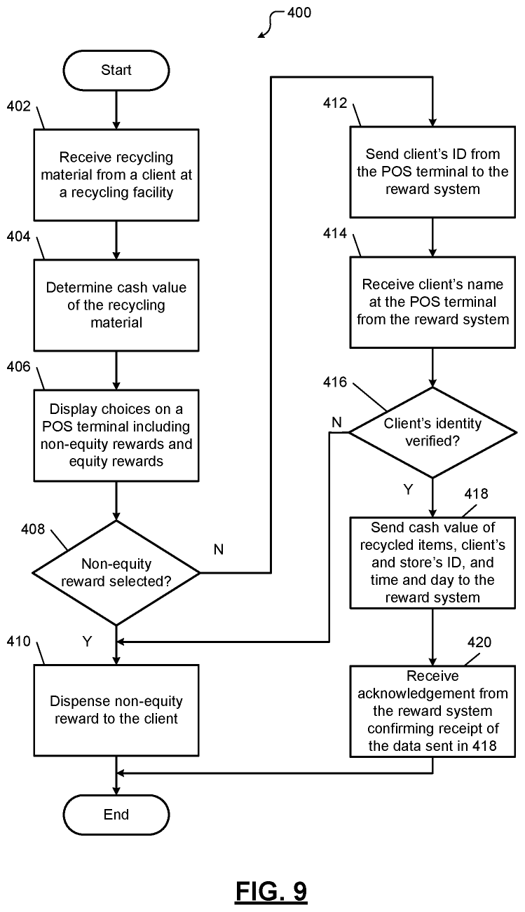

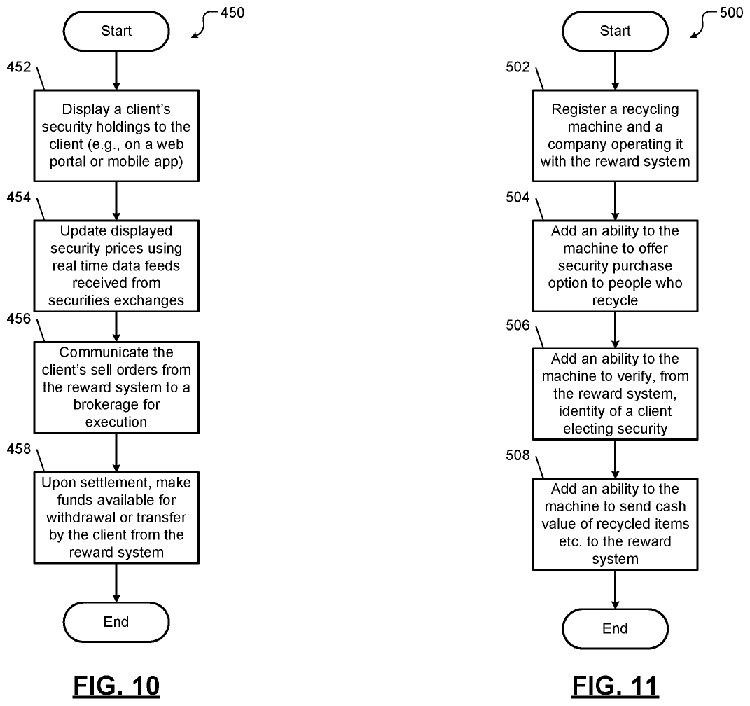

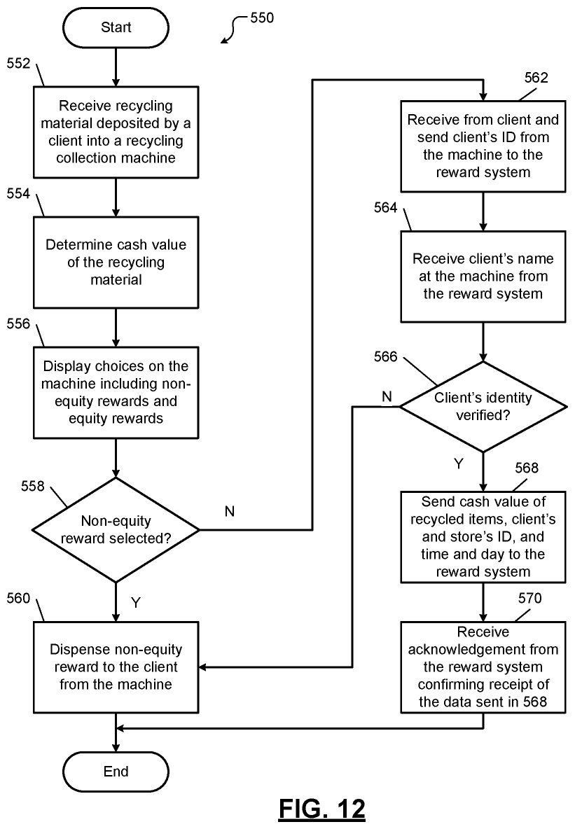

The present disclosure is organized as follows. An overview of the equity reward system of the present disclosure is shown and described with reference to FIG. 1. An example of a recycling facility that can communicate with the equity reward system is shown and described with reference to FIG. 2. A simplified example of a distributed computing system that can implement the equity reward system is shown and described with reference to FIG. 3. Simplified examples of a client device and a server used to implement elements of FIGS. 1-3 are respectively shown in FIGS. 4 and 5. A method for registering a client with the equity reward system is shown and described with reference to FIG. 6. A method for registering a recycling facility with the equity reward system and for providing capabilities to a POS system at the recycling facility to perform the operations of the equity reward system is shown and described with reference to FIG. 7. A method performed by the equity reward system for allocating securities to clients' accounts corresponding to cash values of material recycled by the clients is shown and described with reference to FIG. 8. A method of authenticating a client's identity when the client selects an equity reward option at a recycling facility is shown and described with reference to FIG. 9. A method of updating clients' accounts and facilitating liquidation of clients' holdings in the clients' accounts is shown and described with reference to FIG. 10. A method for registering a recycling machine with the equity reward system and for providing capabilities to the recycling machine to perform the operations described with reference to FIGS. 2, 7, and 9 is shown and described with reference to 11. A method of dispensing equity and non-equity rewards to a client that deposits recycling materials at the recycling machine of FIG. 11 is shown and described with reference to FIG. 12.

FIG. 1 shows a system 10 comprising the equity reward system of the present disclosure, which is shown as a reward system 16. The system 10 further comprises a plurality of recycling facilities 12-1, 12-2, . . . , and 12-N (collectively recycling facilities 12), where N is a positive integer. The system 10 further comprises a recycling machine 14 that is in the form of a self-service recycling kiosk and that is described in detail with reference to FIGS. 11 and 12. While only one recycling machine 14 is shown, the system 10 may comprise a plurality of the recycling machine 14. The system 10 further comprises a brokerage firm 18 and a securities exchange 20. While only one brokerage firm 18 and only one securities exchange 20 is shown, the system 10 may comprise a plurality of the brokerage firm 18 and a plurality of the securities exchange 20.

The system 10 further comprises a distributed communications system 110, which is described with reference to FIG. 3. The recycling facilities 12 and the recycling machine 14 communicate with the reward system 16 via the distributed communications system 110. The reward system 16 communicates with the brokerage firm 18 and optionally with the securities exchange 20 via the distributed communications system 110. The brokerage firm 18 communicates with the reward system 16 and the securities exchange 20 via the distributed communications system 110. The reward system 16 may be implemented in a cloud. For example, the reward system 16 may be distributed as software-as-a-service (SaaS) as explained below.

FIG. 2 shows an example of the recycling facility 12. The recycling facility 12 includes a plurality of recycling machines 50-1, 50-2, . . . , and 50-N (collectively recycling machines 50), a plurality of POS terminals 60-1, 60-2, . . . , 60-N (collectively POS terminals 60), and a POS system 70. The POS system 70 controls the POS terminals 60 and communicates with the reward system 16 via the distributed communications system 110.

For example only, the recycling machines 50 may include machines that accept plastic/glass bottles, aluminum cans, and so on. The recycling machines 50 and/or the recycling facility 12 may receive other materials for recycling. A person such as a client registered with the reward system 16 may recycle items by depositing them in one or more of the recycling machines 50 (or by delivering them to the recycling facility 12). Typically, the recycling machines 50 (or the recycling facility 12) can provide a receipt to the person for the recycle items. The person collects the receipt, proceeds to one of the POS terminals 60, and provides the receipt to a clerk at the POS terminal 60. The POS terminal 60 displays two choices: traditional rewards or equity (security) as a reward in exchange for the recycled items. If the person selects one of the traditional rewards, the clerk dispenses the selected traditional reward to the person.

If the person selects equity as a reward, the clerk asks the person for an ID number, which is given to the person by the reward system 16 when the person registered and opened an account with the reward system 16. The clerk enters the ID number into the POS terminal 60. The POS terminal 60 sends the ID number to the POS system 70, which in turn sends the ID number to the reward system 16 via the distributed communications system 110. The reward system 16 returns the person's name via the distributed communications system 110 to the POS system 70, which in turn sends the person's name to the POS terminal 60.

The clerk at the POS terminal 60 verifies the person's name by checking a government issued ID such as a driver's license or passport (or any other form of reliable identification including a recycling card) of the person. If the name received from the reward systems 16 matches the person's name on the government issued ID, the clerk enters the person's selection of equity as a reward into the POS terminal 60, which in turn sends the selection to the POS system 70.

If the name received from the reward systems 16 does not match the person's name (e.g., due to a typographical or communication error) on the government issued ID, the clerk again enters the person's ID number into the POS terminal 60. The POS terminal 60 sends the ID number to the POS system 70, which in turn sends the ID number to the reward system 16 via the distributed communications system 110. The reward system 16 returns the person's name via the distributed communications system 110 to the POS system 70, which in turn sends the person's name to the POS terminal 60. The clerk at the POS terminal 60 verifies the person's name by checking a government issued ID such as a driver's license of the person. If the name received from the reward systems 16 matches the person's name on the government issued ID, the clerk enters the person's selection of equity as a reward into the POS terminal 60, which in turn sends the selection to the POS system 70.

If the name received from the reward systems 16 still does not match the person's name on the government issued ID (e.g., probably because the person is not a registered client of the reward systems 16), the clerk asks the person to select one of the traditional rewards and dispenses the selected traditional reward to the person.

The POS system 70 may forward the selection along with other transaction data to the reward system 16 immediately (in real time) or later after collecting more transaction data based on receiving recycling materials from more people (in a batch). The transaction data includes the person's ID number, the ID assigned to the recycling facility 12 by the reward system 16 when the recycling facility 12 registered with the reward system 16, a known or assessed cash value of the items recycled by the person at the recycling facility 12, and date and time of day of the transaction. After receiving the transaction data from the POS system 70 in real time or in a batch, the reward system 16 sends an acknowledgement to the POS system 70 confirming that the transaction data has been received by the reward system 16.

In some implementations, the POS terminals 60 can be unmanned (e.g., self-serve type checkout machines or kiosks found in some grocery stores and other stores). In such implementations, the POS terminal 60 may include a scanner to scan the receipt that the person receives from the recycling machine 50 and to scan the person's government issued ID such as a driver's license or passport (or any other form of reliable identification including a recycling card). The person begins a transaction by presenting the receipt to the scanner. The POS terminal 60 may include a touchscreen on which the two choices of rewards (traditional and equity) are displayed after scanning the receipt. If the person selects (e.g., touches) the traditional rewards option, further selections are displayed (e.g., points, vouchers, coupons, cash, etc.). Based on the further selection made by the person, the POS terminal 60 dispenses the selected traditional reward.

Instead, if the person selects (e.g., touches) the equity option, the POS terminal 60 displays a prompt for the person to enter the ID number issued to the person by the reward system 16. The person enters the ID number into the POS terminal 60 (e.g., using a keypad displayed on the touch screen). The POS terminal 60 sends the ID number to the POS system 70, which in turn sends the ID number to the reward system 16 via the distributed communications system 110. The reward system 16 returns the person's name via the distributed communications system 110 to the POS system 70, which in turn sends the person's name to the POS terminal 60.

Next, the POS terminal 60 displays a prompt for the person to scan a government issued ID such as a driver's license or passport (or any other form of reliable identification including a recycling card) of the person. The POS terminal 60 compares the person's name received from the reward system 16 to the person's name found on the government issued ID. In some implementations, the POS terminal 60 sends the person's name found on the government issued ID to the POS system 70, and the comparison is made by the POS system 70. If the name received from the reward systems 16 matches the person's name on the government issued ID, the POS terminal 60 accepts the person's selection of equity as a reward and sends the selection to the POS system 70.

If the name received from the reward systems 16 does not match the person's name (e.g., due to a typographical or communication error) on the government issued ID, the POS terminal 60 again prompts the person to enter the person's ID number into the POS terminal 60. The POS terminal 60 again sends the ID number to the POS system 70, which in turn sends the ID number to the reward system 16 via the distributed communications system 110. The reward system 16 returns the person's name via the distributed communications system 110 to the POS system 70, which in turn sends the person's name to the POS terminal 60. The POS terminal 60 may prompt the person to again scan the government issued ID. The POS terminal 60 compares the person's name received from the reward system 16 to the person's name found on the government issued ID. In some implementations, the POS terminal 60 sends the person's name found on the government issued ID to the POS system 70, and the comparison is made by the POS system 70. If the name received from the reward systems 16 matches the person's name on the government issued ID, the POS terminal 60 accepts the person's selection of equity as a reward and sends the selection to the POS system 70.

The POS system 70 may forward the selection along with other transaction data to the reward system 16 immediately or later after collecting more transaction data based on receiving recycling materials from more people. The transaction data includes the person's ID number, the ID assigned to the recycling facility 12 by the reward system 16, and a known or assessed cash value of the items recycled by the person at the recycling facility 12. The reward system 16 sends an acknowledgement to the POS system 70 confirming receipt of the transaction data.

If the name received from the reward systems 16 still does not match the person's name on the government issued ID (e.g., probably because the person is not a registered client of the reward systems 16), the POS terminal 60 rejects the person's selection of equity as a reward. The POS system 70 treats the transaction as if the person selected the traditional rewards option, and displays further selections (e.g., points, vouchers, coupons, cash, etc.). Based on the further selection made by the person, the POS terminal 60 dispenses the selected traditional reward.

In some implementations, the kiosk type POS terminal 60 may be equipped with a scanner that can scan a person's biometric information. In such implementations, the person may be prompted on the POS terminal 60 to present the person's biometric information (e.g., to touch or face a scanner associated with the POS terminal 60). The POS terminal 60 can then send the person's biometric information (e.g., captured by the scanner on the POS terminal 60) to the reward system 16 to verify the person's identity.

In some implementations, some of the functionality of the POS terminal 60 such as the scanner and the touchscreen can be incorporated into the recycling machines 50. In such implementations, these enhanced recycling machines 50 can communicate directly with the POS system 70 and through the POS system 70 with the reward system 16. Alternatively, these enhanced recycling machines 50 can communicate directly with the reward system 16 via the distributed communications system 110 (i.e., without requiring the POS system 70). For example, these enhanced machines can be in the form of self-service recycling kiosks and may therefore be also called self-service recycling kiosks. An example of such an enhanced recycling machine 50 is shown as the recycling machine 14 in FIG. 1 and is described with reference to FIGS. 11 and 12.

Below are simplistic examples of a distributed computing environment in which the systems and methods of the present disclosure can be implemented. Throughout the description, references to terms such as servers, client devices, applications and so on are for illustrative purposes only. The terms server and client device are to be understood broadly as representing computing devices with one or more processors and memory configured to execute machine readable instructions. The terms application and computer program are to be understood broadly as representing machine readable instructions executable by the computing devices.

FIG. 3 shows a simplified example of a distributed computing system 100. The distributed computing system 100 includes the distributed communications system 110 (shown in FIGS. 1 and 2), one or more client devices 120-1, 120-2, . . . , and 120-M (collectively, client devices 120), and one or more servers 130-1, 130-2, . . . , and 130-N (collectively, servers 130). M and N are integers greater than or equal to one. The distributed communications system 110 may include a local area network (LAN), a wide area network (WAN) such as the Internet, or other type of network. The client devices 120 and the servers 130 may be located at different geographical locations and communicate with each other via the distributed communications system 110. The client devices 120 and the servers 130 may connect to the distributed communications system 110 using wireless and/or wired connections.

For example, the client devices 120 may include smartphones, personal digital assistants (PDAs), tablets, laptop computers, personal computers (PCs), etc. For example, the clients of the reward system 16 may use the client devices 120 to interact with the reward system 16 via the distributed communications system 110. The client devices 120 may also implement the POS system 70 and the recycling machines 14. The POS system 70 and the recycling machines 14 may also interact with the reward system 16 via the distributed communications system 110. The client devices 120 (e.g., clients' mobile phones and/or laptops, the POS system 70, and the recycling machines 14) may execute suitable applications (shown as client applications 166 in FIG. 4) to perform respective functions described above.

One or more of the servers 130 may implement the reward system 16. The servers 130 may provide multiple services to the client devices 120. One or more of the servers 130 may implement securities trading systems at the brokerage firms 18 and at the securities exchanges 20. For example, the servers 130 may execute software applications developed by one or more vendors (shown as applications 186 in FIG. 5). The servers 130 may host multiple databases (shown as applications 188 in FIG. 5) that are relied on by the software applications in providing services to users of the client devices 120 (e.g., clients' mobile phones and/or laptops, the POS system 70, and the recycling machines 14). The servers 130 implementing the reward system 16 may be implemented in a cloud. For example, the software applications executed by the servers 130 to implement the reward system 16 may be distributed as software-as-a-service (SaaS).

FIG. 4 shows a simplified example of the client device 120-1. As mentioned above, the client device 120-1 may be any one of the clients' mobile phones and/or laptops, the POS system 70, and the recycling machines 14. The client device 120-1 may typically include a central processing unit (CPU) or processor 150, one or more input devices 152 (e.g., a keypad, touchpad, mouse, touchscreen, scanner, etc.), one or more output devices 153 (e.g., a dispenser to dispense cash, coupons, receipts, etc. when the client device 120-1 is the recycling machine 14), a display subsystem 154 including a display 156, a network interface 158, memory 160, and bulk storage 162.

The network interface 158 connects the client device 120-1 to the distributed computing system 100 via the distributed communications system 110. For example, the network interface 158 may include a wired interface (e.g., an Ethernet interface) and/or a wireless interface (e.g., a Wi-Fi, Bluetooth, near field communication (NFC), or other wireless interface). The memory 160 may include volatile or nonvolatile memory, cache, or other type of memory. The bulk storage 162 may include flash memory, a magnetic hard disk drive (HDD), and other bulk storage devices.

The processor 150 of the client device 120-1 executes an operating system (OS) 164 and one or more client applications 166. The client applications 166 include an application that accesses the servers 130 via the distributed communications system 110. For example, the client applications 166 may include mobile apps that the client devices 120 can use to interact with the reward system 16. The client applications 166 may also perform the functions of the POS system 70 and the recycling machines 14 as described above when the client devices 120 implement the POS system 70 and the recycling machines 14.

FIG. 5 shows a simplified example of the server 130-1. As mentioned above, the server 130-1 may implement the reward system 16. The server 130-1 typically includes one or more CPUs or processors 170, a network interface 178, memory 180, and bulk storage 182. In some implementations, the server 130-1 may be a general-purpose server and include one or more input devices 172 (e.g., a keypad, touchpad, mouse, and so on) and a display subsystem 174 including a display 176.

The network interface 178 connects the server 130-1 to the distributed communications system 110. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more magnetic hard disk drives (HDDs), or other bulk storage devices.

The processor 170 of the server 130-1 executes an operating system (OS) 184 and one or more server applications 186, which may be housed in a virtual machine hypervisor or containerized architecture, which include the reward system 16. The bulk storage 182 may store one or more databases 188 that store data structures used by the server applications 186 to perform respective functions. For example, the server applications 186 may perform the functions of the reward system 16.

FIG. 6 shows a method 200 for registering a client with the reward system 16. The client can use one of the client devices 120 (e.g., a smartphone or a laptop) to register with the reward system 16. The method 200 can be performed partially by one of the client applications 166 (e.g., a mobile app) executed by one of the client devices 120 and partially by one of the server applications 186 (e.g., a web portal) executed by one of the servers 130 implementing the reward system 16. For example, the portion of the method 200 executed by the servers 130 may be implemented in a cloud and may be distributed as software-as-a-service (SaaS).

At 202, the reward system 16 receives the clients personal information (e.g., name, address, contact information, social security number, biometric information, etc.; essentially similar information that is typically required to open a bank account, for example). At 204, the reward system 16 registers the client and opens an account for the client at the reward system 16. At 206, the reward system 16 receives the client's security preferences (e.g., stock symbols a company names). At 208, based on the client's security preferences, the reward system 16 creates and stores a client's profile in a client's database in the reward system 16. At this point, the reward system 16 assigns an ID number (and optionally issue a recycling card) to the client, and the client is eligible to select the security reward option when recycling materials at recycling facilities 12 that are also registered with the reward system 16.

FIG. 7 shows a method 250 for registering a recycling facility (e.g., element 12 shown in FIG. 1) with the reward system 16 and for providing capabilities to the POS system (e.g., elements 60 and 70 shown in FIG. 2) to perform the functions described above with reference to FIG. 2. The recycling facility 12 can use one of the client devices 120 (e.g., a smartphone or a laptop) to register with the reward system 16. The method 250 can be performed partially by one of the client applications 166 (e.g., a mobile app) executed by one of the client devices 120 and partially by one of the server applications 186 (e.g., a web portal) executed by one of the servers 130 implementing the reward system 16. For example, the portion of the method 250 executed by the servers 130 may be implemented in a cloud and may be distributed as software-as-a-service (SaaS).

At 252, the reward system 16 receives identifying information from the recycling facility 12 (e.g., via a mobile app or a web portal of the reward system 16) and registers the recycling facility 12 with the reward system 16. For example, the identifying information may include the name and address of the recycling facility 12. The reward system 16 assigns an ID number to the recycling facility 12 upon completion of the registration process.

At 254, the POS system (e.g., elements 60 and 70 shown in FIG. 2) of the recycling facility 12 is extended (i.e., augmented or configured) to offer the security purchase option to people who recycle at the recycling facility 12. For example, any new or additional hardware and/or software that can provide the POS system the ability to offer and process the security purchase option as described above with reference to FIG. 2 is provided to the POS system of the recycling facility 12.

At 256, the POS system (e.g., elements 60 and 70 shown in FIG. 2) of the recycling facility 12 is further extended (i.e., augmented or configured) to verify, from the reward system 16, the identity of a person who recycles material at the recycling facility 12 and selects the security purchase option as a reward for the recycled material. For example, any new or additional hardware and/or software that can provide the POS system the ability to verify the identity of a person who recycles material at the recycling facility 12 as described above with reference to FIG. 2 is provided to the POS system of the recycling facility 12.

At 258, the POS system (e.g., elements 60 and 70 shown in FIG. 2) of the recycling facility 12 is extended (i.e., augmented or configured) to compute and send a cash value of the recycled items along with other transaction data (e.g., client's and recycling facility's IDs, time and date, etc.) to the reward system 16. For example, any new or additional hardware and/or software that can provide the POS system the ability to compute and send to the reward system 16 the cash value of the recycled items along with other transaction data as described above with reference to FIG. 2 is provided to the POS system of the recycling facility 12. At this point, the recycling facility 12 is ready to offer the equity option to people recycling material at the recycling facility 12, verify people's identities and registration with the reward system 16, and send transaction data to the reward system 16 as described above with reference to FIG. 2.

FIG. 8 shows a method 300 performed by the reward system 16 for allocating securities to clients' accounts corresponding to cash values of material recycled by the clients. The method 300 can be performed by one of the server applications 186 executed by one of the servers 130 implementing the reward system 16. For example, the method 300 executed by the servers 130 may be implemented in a cloud and may be distributed as software-as-a-service (SaaS).

At 302, the reward system 16 purchases a basket of securities (e.g., stocks of recycling facilities 12 registered with the reward system 16, stocks of other companies, etc.). The reward system 16 may purchase the securities at any time during the day. For example, the reward system 16 may purchase securities for a recycling facility 12 as soon as transaction data is received from the recycling facility 12. Alternatively, the reward system 16 may accumulate transaction data received from one or more recycling facilities 12 and then purchase the securities. In other examples, the reward system 16 may purchase the basket of securities at one or more predetermined times during the day without regard to transaction data received from one or more recycling facilities 12. In some implementations, the reward system 16 may purchase the securities through the brokerage firm 18. In other implementations, if the reward system 16 is authorized to trade securities on the securities exchanges 20, the reward system 16 may purchase the securities directly from one or more securities exchanges 20.

At 304, the reward system 16 receives transaction data from the recycling facilities 12 including cash values of the recycled materials. The transaction data may be received in real time (i.e., as soon as the receipt of the recycling materials is processed at the recycling facility 12 as described with reference to FIG. 2 above) or in batches as described with reference to FIG. 2 above.

At 306, after each receipt of the transaction data from the POS system 70, whether in real time or in batches, the reward system 16 sends an acknowledgement to the recycling facilities 12 confirming that the transaction data has been received by the reward system 16.

At 308, the reward system 16 may accumulate transaction data in clients' accounts in a temporary database in the reward system 16 or may accumulate all non-settled transactions in one temporary database without reflecting the transactions in clients' accounts until they are settled, as described above with reference to FIG. 2.

At 310, the reward system 16 allocates securities from the purchased basket of securities to clients' accounts in the reward system 16, where the amount of securities are equivalent (i.e., proportional) to the cash values of recycled items by the clients. At this point, the client is able to view security holdings in the client's account and can sell the securities if desired.

FIG. 9 shows a method 400 of authenticating a client's identity when the client selects the equity reward option at a recycling facility 12. The method 400 can be performed partially by one of the client applications 166 executed by one or more of the client devices 120 (e.g., a POS terminal 60 and/or the POS system 70 at the recycling facility 12) and partially by one of the server applications 186 executed by one of the servers 130 implementing the reward system 16. For example, the portion of the method 400 executed by the servers 130 may be implemented in a cloud and may be distributed as software-as-a-service (SaaS).

At 402, a recycling machine (e.g., element 50 shown in FIG. 2) receives recycling material (e.g., bottles, cans, etc.) from a client at the recycling facility 12. At 404, a cash value of the recycled material is determined at the recycling facility (e.g., by the recycling machine 50, the POS terminal 60, or the POS system 70 shown in FIG. 2). At 406, choices including equity rewards and traditional non-equity awards are provided to the client (e.g., displayed on the POS terminal 60). At 408, the client selects either one of the traditional non-equity rewards or the equity reward.

At 410, if the client selects the traditional non-equity reward, the selected non-equity award (e.g., cash, coupon, etc.) is dispensed to the client (e.g., at the POS terminal 60). At 412, if the client selects the equity reward, the client's ID number, which is assigned to the client by the reward system 16, is sent from the POS terminal 60 to the reward system 16 (e.g., via the POS system 70) for verifying the client's identity. At 414, the POS terminal 60 receives the client's name from the reward system 16 (e.g., via the POS system 70). At 416, the clerk at the POS terminal 60 checks the received name against a government issued ID such as a driver's license (or any other form of reliable identification including a recycling card issued by the equity reward system) of the client. At 418, if the received name matches the name on the government issued ID, the POS terminal 60 sends transaction data including the cash value of the recycled items, the client's and the store's IDs issued by the reward system 16, and time and date of the transaction to the reward system 16.

At 418, if the received name does not match the name on the government issued ID, the POS terminal 60 resends the client's ID number to the reward system 16 (e.g., via the POS system 70) for verifying the client's identity. The POS terminal 60 again receives the client's name from the reward system 16 (e.g., via the POS system 70). If the received name matches the name on the government issued ID, the POS terminal 60 sends transaction data including the cash value of the recycled items, the client's and the store's IDs issued by the reward system 16, and time and date of the transaction to the reward system 16. At 420, the POS system 70 receives an acknowledgement from the reward system 16 indicating receipt of the transaction data from the POS system 70. At 410, if the received name again does not match the name on the government issued ID, the POS terminal 60 dispenses a non-equity award (e.g., cash, coupon, etc.) to the client.

In some implementations, for example, if the POS terminal is a self-service check-out type kiosk, the client may be prompted on the POS terminal 60 to present the client's biometric information (e.g., to touch or face a scanner associated with the POS terminal 60). The POS terminal 60 can then send the client's biometric information (e.g., captured by the scanner on the POS terminal 60) to the reward system 16 to verify the client's identity.

FIG. 10 shows a method 450 of updating clients' accounts and facilitating liquidation of clients' holdings in the clients' accounts. The method 450 can be performed partially by a client device 120 (e.g., a client's mobile phone running an app provided by the reward system 16) and partially by one of the server applications 186 executed by one of the servers 130 implementing the reward system 16. For example, the portion of the method 450 executed by the servers 130 may be implemented in a cloud and may be distributed as software-as-a-service (SaaS).

At 452, a client of the reward system 16 can log into the reward system 16 (e.g., via a mobile app or a web portal of the reward system 16) and view its security holdings in its account with the reward system 16 (e.g., after element 308 shown in FIG. 8). At 454, the values or the prices of the displayed securities are updated using real-time data feeds received by the reward system 16 from the securities exchanges 20.

At 456, the client may decide to sell one of the securities in its account. The reward system 16 communicates the client's sell order to a brokerage firm 18 or, directly to one of the security exchanges 20 if the reward system 16 is authorized to trade securities. At 456, upon settlement of the trade, the reward system 16 makes the funds available to the client in the client's account for withdrawal or transfer by the client from the client account.

FIG. 11 shows a method 500 for registering a recycling machine (e.g., element 14 shown in FIG. 1 or the enhanced recycling machine 50 described with reference to FIG. 2) with the reward system 16 and for providing capabilities to the recycling machine to perform the functions described above with reference to FIGS. 2, 7, and 9. The method 500 can be performed partially by one of the client applications 166 executed by a client device 120 (the recycling machine 14 being the client device 120) and partially by one of the server applications 186 (e.g., a web portal) executed by one of the servers 130 implementing the reward system 16. For example, the portion of the method 500 executed by the servers 130 may be implemented in a cloud and may be distributed as software-as-a-service (SaaS).

The recycling machine 14 may be located at one of the recycling facilities 12 or elsewhere as a complete, self-sufficient, standalone recycling facility. That is, the recycling machine 14 is capable of receiving recycling material, assessing value of the recycled material, offering traditional and equity reward options, and processing a selected option. In other words, the recycling machine 14 can be in the form of a self-service recycling kiosk and may therefore be also called a self-service recycling kiosk. The recycling machine 14 may be managed by a company similar to a company that manages vending machines, for example. In some examples, the recycling machine 14 is able to accept recycling materials similar to the recycling machine 50 found at grocery stores, for example, and is additionally equipped with a terminal similar to the POS terminal 60 described above. Further, the recycling machine 14 is able to offer equity and non-equity (i.e., traditional) reward choices to the clients of the reward system 16. The recycling machine 14 is able to dispense the non-equity rewards to the clients. Alternatively, the recycling machine 14 is able to accept the client's selection of the equity reward and send the transaction data to the reward system 16 after verifying the client's identity as described above with reference to FIG. 9. The method 500 is described below in detail.

At 502, the reward system 16 receives identifying information from the recycling machine 14 (e.g., via a web portal or a mobile app executed by a company managing the recycling machine 14) and registers the recycling machine 14 with the reward system 16. For example, the identifying information may include the name and address of the company managing the recycling machine 14 and an identifier identifying the recycling machine 14. The reward system 16 registers the company managing the recycling machine 14 and assigns an ID number to the recycling machine 14 upon completion of the registration process.

At 504, the recycling machine 14 is equipped with a terminal similar to a POS terminal (e.g., the POS terminal 60 shown in FIG. 2) to offer the equity and non-equity reward choices to people who recycle material at the recycling machine 14. For example, any hardware and/or software that can provide the recycling machine 14 with the ability to offer and process the equity and non-equity reward choices as described above is provided to the terminal of the recycling machine 14.

At 506, the terminal of the recycling machine 14 is further provided with the ability to verify, from the reward system 16, the identity of a person who recycles material at the recycling machine 14 and selects the security purchase (i.e., equity) option as a reward for the recycled items. For example, any hardware (e.g., a scanner that can scan a person's driver's license or a recycling card or biometric information) and/or software that can provide the terminal the ability to verify the identity of a person who recycles material at the recycling machine 14 as described above is provided to the terminal of the recycling machine 14.

At 508, the terminal of the recycling machine 14 is further provided with the ability to compute and send a cash value of the recycled items along with other transaction data (e.g., client's and recycling machine's IDs, time and date, etc.) to the reward system 16. For example, any hardware and/or software that can provide the terminal the ability to compute and send the cash value of the recycled items along with other transaction data as described above is provided to the terminal of the recycling machine 14. At this point, the recycling machine 14 is ready to accept recycling materials, value the recycled materials, offer the equity and non-equity options to people recycling material at the recycling machine 14, verify people's identities and registration with the reward system 16, and send transaction data to the reward system 16 as described above.

FIG. 12 shows a method 550 of dispensing equity and non-equity rewards to a client that deposits recycling materials at a recycling machine such as the recycling machine 14. The method 550 can be performed partially by one of the client applications 166 executed by a client device 120 (the recycling machine 14 being the client device 120) and partially by one of the server applications 186 executed by one of the servers 130 implementing the reward system 16. For example, the portion of the method 550 executed by the servers 130 may be implemented in a cloud and may be distributed as software-as-a-service (SaaS).

At 552, the recycling machine 14 receives recycling material (e.g., bottles, cans, etc.) from a client. At 554, a cash value of the recycled material is determined at the recycling machine 14 (e.g., by the recycling machine 14 and/or by the company that operates and manages the recycling machine 14). At 556, choices including equity and traditional non-equity rewards are provided to the client (e.g., displayed on a terminal of the recycling machine 14, which can be similar to the POS terminal 60). At 558, the client selects either one of the traditional non-equity rewards or the equity reward (e.g., by touching the selection on a touchscreen on the terminal of the recycling machine 14 or by using a keypad on the recycling machine 14—e.g., the input device 152 shown in FIG. 4).

At 560, if the client selects the traditional non-equity reward, the selected non-equity award (e.g., cash, coupon, etc.) is dispensed to the client through a dispenser of the recycling machine 14 (e.g., the output device 153 shown in FIG. 4). At 562, if the client selects the equity reward, the client is prompted on the terminal of the recycling machine 14 to enter the client's ID number, which is assigned to the client by the reward system 16. For example, the client may enter the ID number using a touchscreen on the terminal or using a keypad on the recycling machine 14 (e.g., the input device 152 shown in FIG. 4). The client's ID number is sent from the recycling machine 14 to the reward system 16 (e.g., via the distributed communications system 110 shown in FIG. 1) for verifying the client's identity.

At 564, the recycling machine 14 receives the client's name from the reward system 16 (e.g., via the distributed communications system 110). At 566, the recycling machine 14 may prompt the client on the terminal of the recycling machine 14 to insert or scan a government issued ID such as a driver's license (or any other form of reliable identification including a recycling card issued by the equity reward system) of the client (e.g., in the input device 152 shown in FIG. 4). The recycling machine 14 compares the received name against the name scanned on the government issued ID. In some implementations, the recycling machine 14 may send the received name and the scanned data to the company managing the recycling machine 14 for comparison.

At 568, if the received name matches the name on the government issued ID, the recycling machine 14 sends transaction data including the cash value of the recycled items, the client's and the recycling machine's IDs issued by the reward system 16, and time and date of the transaction to the reward system 16. If the received name does not match the name on the government issued ID, the recycling machine 14 resends the client's ID number to the reward system 16 for verifying the client's identity. The recycling machine 14 again receives the client's name from the reward system 16. If the received name matches the name on the government issued ID, the recycling machine 14 sends transaction data including the cash value of the recycled items, the client's and the store's IDs issued by the reward system 16, and time and date of the transaction to the reward system 16. At 570, the recycling machine 14 receives an acknowledgement from the reward system 16 indicating receipt of the transaction data from the recycling machine 14. At 560, if the received name again does not match the name on the government issued ID, the recycling machine 14 dispenses a non-equity reward (e.g., cash, coupon, etc.) to the client through a dispenser of the recycling machine 14 (e.g., through the output device 153 shown in FIG. 4).

In some implementations, the client may be prompted on the terminal of the recycling machine 14 to present the client's biometric information (e.g., to touch or face a scanner on the recycling machine 14). The recycling machine 14 can then send the client's biometric information (e.g., captured by the scanner on the recycling machine 14) to the reward system 16 to verify the client's identity.

For any reason, if there is any problem in dispensing a non-equity reward or in communicating with the reward system 16, the recycling machine 14 dispenses a receipt (e.g., through one of the output devices 153 shown in FIG. 4) for the recycled items deposited by the client into the recycling machine 14. The client can then obtain the selected reward from either the company managing the recycling machine 14 or from the reward system 16.

Thus, unlike the conventional reward systems, the reward system of the present disclosure incentivizes more people to recycle more materials by offering equity rewards. The reward system of the present disclosure also improves operations of the recycling facilities by upgrading their equipment in various ways described above. The recycling facilities can also experience business growth in many areas including recycling, increased trading of their securities (e.g., stocks), and increased sale of other products (e.g., groceries) as more people, incentivized by the reward system, visit their facilities to recycle materials. Further, the reward system also provides standalone recycling machines (i.e., the serf-service recycling kiosks) that are presently nonexistent and that provide a one stop shop for recycling public to obtain the enhanced benefits provided by the reward system of the present disclosure. In this manner, the reward system of the present disclosure significantly contributes to the progress of the recycling industry and improves the overall recycling industry. Furthermore, the reward system of the present disclosure incentivizes more people to recycle, which further benefits the recycling industry, the recycling public, and the earth as a whole.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system to reward persons for recycling materials at recycling facilities, the system comprising:
a processor; and
memory storing instructions, which when executed by the processor, cause the processor to:
register the recycling facilities and the persons that recycle the materials at the recycling facilities;
purchase a plurality of securities including securities associated with the recycling facilities and securities of interest to the persons;
receive, from a first recycling facility of the recycling facilities, in response to a first person of the persons recycling the materials at the first recycling facility, a value of the recycled materials and identifying information of the first recycling facility and of the first person; and
allocate a portion of the plurality of securities to an account associated with the first person based on the value of the recycled materials and the identifying information of the first recycling facility and of the first person received from the first recycling facility.

2. The system of claim 1 wherein the instructions further cause the processor to, in response to the first person recycling the materials at the first recycling facility, prior to receiving the value of the recycled materials and the identifying information of the first recycling facility and of the first person:
receive, from the first recycling facility, a first identifying information provided to the first person by the system when the first person registered with the system; and
send, to the first recycling facility, in response to receiving the first identifying information, a second identifying information provided to the system by the first person when the first person registered with the system.

3. The system of claim 1 wherein the instructions further cause the processor to, in response to a plurality of the persons recycling the materials at the first recycling facility, receive from the first recycling facility in real-time or in one or more batches, values of the recycled materials and identifying information of the first recycling facility and of the plurality of the persons.

4. The system of claim 1 wherein the instructions further cause the processor to:
display the allocated securities in the account associated with the first person; and
update prices of the displayed securities based on real-time data feeds received from a securities exchange.

5. The system of claim 1 wherein the instructions further cause the processor to:
allow the first person to sell the allocated securities; and
communicate, directly or via a brokerage firm, a sell order of the first person to a securities exchange.

6. The system of claim 1 further comprising a network interface configured to communicate with the recycling facilities, a securities exchange, and a brokerage firm via a communications network.

7. A system to reward a person registered with a reward system for recycling materials at a recycling facility also registered with the reward system, the system comprising:
a processor; and
memory storing instructions, which when executed by the processor, cause the processor to:
provide the person, in response to receiving the materials from the person at the recycling facility, an option to purchase securities or to receive an item in exchange for the materials;
receive from the person, in response to the person selecting the option to purchase securities, a first identifying information provided to the person by the reward system when the person registered with the reward system;
send the first identifying information to the reward system;
receive, in response to sending the first identifying information to the reward system, a second identifying information from the reward system, wherein the second identifying information is provided to the reward system by the person when the person registered with the reward system;
confirm an identity of the person based on the second identifying information received from the reward system; and
send to the reward system, for allocating the securities proportional to a value of the materials to an account of the person, in response to confirming the identity of the person, the value of the materials, the first identifying information of the person, and an identifying information of the recycling facility provided by the reward system to the recycling facility when the recycling facility registered with the reward system.

8. The system of claim 7 wherein in response to being unable to confirm the identity of the person based on the second identifying information, the instructions further cause the processor to again:
receive the first identifying information from the person;
send the first identifying information to the reward system;
receive the second identifying information from the reward system; and
confirm the identity of the person based on the second identifying information.

9. The system of claim 8 wherein:
in response to again being unable to confirm the identity of the person based on the second identifying information, the instructions further cause the processor to allow dispensing the item of value equivalent to the value of the materials to the person in exchange for the materials; and
the item includes cash, coupon, points, or voucher.

10. The system of claim 7 further comprising:
a point of sale terminal; and
a scanner configured to scan a receipt indicating the value of the materials,
wherein the instructions further cause the processor to display on the point of sale terminal:
the value of the materials by scanning the receipt; and
the option to purchase the securities or to receive the item in exchange for the materials.

11. The system of claim 7 further comprising:
a scanner configured to scan an identification of the person;
wherein the instructions further cause the processor to:
obtain a third identifying information by scanning the identification; and
confirm the identity of the person based on the second and third identifying information.

12. The system of claim 11 wherein in response to being unable to confirm the identity of the person based on the second and third identifying information, the instructions further cause the processor to again:
receive the first identifying information from the person;
send the first identifying information to the reward system;
receive the second identifying information from the reward system;
obtain the third identifying information; and
confirm the identity of the person based on the second and third identifying information.

13. The system of claim 12 wherein:
in response to again being unable to confirm the identity of the person based on the second and third identifying information, the instructions further cause the processor to dispense the item of value equivalent to the value of the materials to the person in exchange for the recycling material; and
the item includes cash, coupon, points, or voucher.

14. The system of claim 7 further comprising a network interface configured to communicate with the reward system via a communications network.

15. A machine registered with a reward system that rewards persons for recycling materials, the machine configured to receive recycling material from a person who is also registered with the reward system, the machine comprising:
a receptacle to receive the recycling material from the person;
a processor; and
memory storing instructions, which when executed by the processor, cause the processor to:
display, in response to receiving the recycling material, an option to purchase securities or to receive an item in exchange for the recycling material;
receive from the person, in response to the person selecting the option to purchase securities, a first identifying information provided to the person by the reward system when the person registered with the reward system;
send the first identifying information to the reward system;
receive, in response to sending the first identifying information, a second identifying information from the reward system, wherein the second identifying information is provided to the reward system by the person when the person registered with the reward system;
receive a third identifying information from the person;
confirm an identity of the person based on the second and third identifying information; and
send to the reward system, for allocating the securities proportional to a value of the recycling material to an account of the person, in response to confirming the identity of the person, the value of the recycling material, the first identifying information of the person, and an identifying information assigned to the machine by the reward system when the machine was registered with the reward system.

16. The machine of claim 15 wherein the instructions further cause the processor to determine the value of the recycling material and to display the value along with the option to purchase the securities or to receive the item in exchange for the recycling material.

17. The machine of claim 15 further comprising a scanner configured to scan an identification of the person, wherein the instructions further cause the processor to obtain the third identifying information by scanning the identification.

18. The machine of claim 15 wherein in response to being unable to confirm the identity of the person based on the second and third identifying information, the instructions further cause the processor to again:
receive the first identifying information from the person;
send the first identifying information to the reward system;
receive the second identifying information from the reward system;
receive the third identifying information from the person; and
confirm the identity of the person based on the second and third identifying information.

19. The machine of claim 18 wherein:
in response to again being unable to confirm the identity of the person based on the second and third identifying information, the instructions further cause the processor to dispense the item of value equivalent to the value of the recycling material to the person in exchange for the recycling material; and
the item includes cash, coupon, points, or voucher.

20. The machine of claim 15 further comprising a network interface configured to communicate with the reward system via a communications network.
